(19) United States
(12) Patent Application Publication
(10) Pub. No.: US 2010/0106553 A1
(43) Pub. Date: Apr. 29, 2010

(54) COMMUNICATION DEVICE AND AGENDA MANAGING METHOD THEREOF

(75) Inventor: FU-BIN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/547,618

(22) Filed: Aug. 26, 2009

(30) Foreign Application Priority Data
Oct. 28, 2008 (CN) 200810305257.2

(51) Int. Cl. G06Q 10/00

(52) U.S. Cl. 705/9

(57) ABSTRACT

A communication device and method for managing agendas includes setting options for each of the agenda, generating the agendas, and retrieving contact information from a contact option of each of the agendas. The communication device and the method further includes determining one or more contacts corresponding to the agendas according to the retrieved contact information, and generating an agenda contact group comprising the determined one or more contacts.

### BACKGROUND

1. Technical Field

Embodiments of the present disclosure relate to data management, and more particularly to a communication and method for managing agendas in the communication device.

2. Description of Related Art

Many communication devices (e.g., mobile phones) provide agenda functions for people to establish agendas. The agendas may remind people to attend a meeting, visit a friend, or buy something, for example. However, if people want to find a contact corresponding to an agenda, they cannot acquire contact information of the contact from the agenda directly.

What is needed, therefore, is an improved communication device and method for managing agendas in the communication device.

### BRIEF DESCRIPTION OF THE DRAWINGS

FIG. 1 is a block diagram of one embodiment of a communication device including a managing system.

FIG. 2 is a block diagram of one embodiment of the managing system.

FIG. 3 is a flowchart of one embodiment of a method for managing agendas in the communication device of FIG. 1.

FIG. 4 is a flowchart of one embodiment of a method for filtering agendas.

FIG. 5 and FIG. 6 are schematic diagrams of one embodiment of user interfaces provided by the managing system of FIG. 2.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

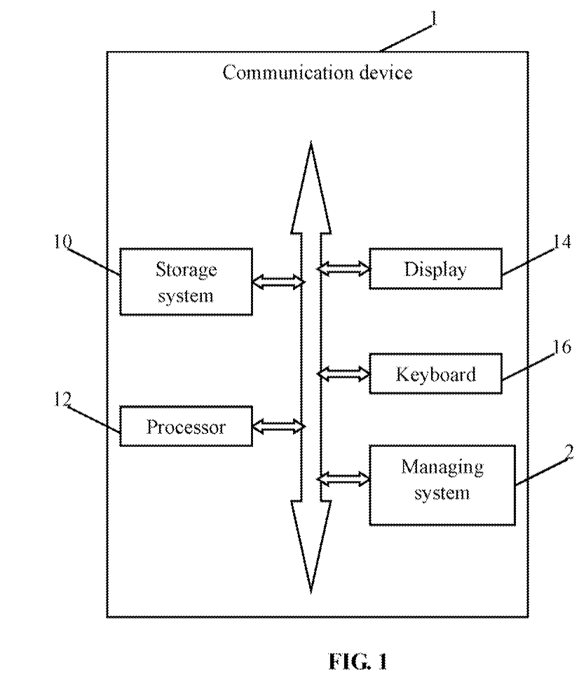

FIG. 1 is a block diagram of one embodiment of a communication device 1 including a managing system 2. The managing system 2 may be used to manage agendas in the communication device 1 by setting a contact option for each of the agendas and generating an agenda contact group including or more contacts corresponding to the agendas. In one embodiment, the contact option may be selected to input contact information corresponding to each agenda. The contact information includes a contact name, a mobile phone number, and an E-mail address, for example.

The communication device 1 may be a mobile phone, a personal digital assistant, a handheld computer, or any other kind of computing device. The communication device 1 may also include a storage system 10 and a processor 12. The storage system 10 stores one or more programs, such as programs of an operating system, other applications of the communication device 1, and various kinds of data, such as agendas, messages, contact information, for example. In one embodiment, the communication device 1 may be a mobile phone, and the storage system 10 may be a memory of the communication device 1 or an external storage card, such as a memory stick, a subscriber identification module (SIM) card, a smart media card, a compact flash card, or any other type of memory card. The processor 12 executes one or more computerized operations of the communication device 1 and other applications, to provide functions of the communication device 1.

The communication device 1 may further include a display 14 and a keyboard 16. The display 14 may display or output visible data, such as the messages, the agendas, images, for example. The keyboard 16 receives data input.

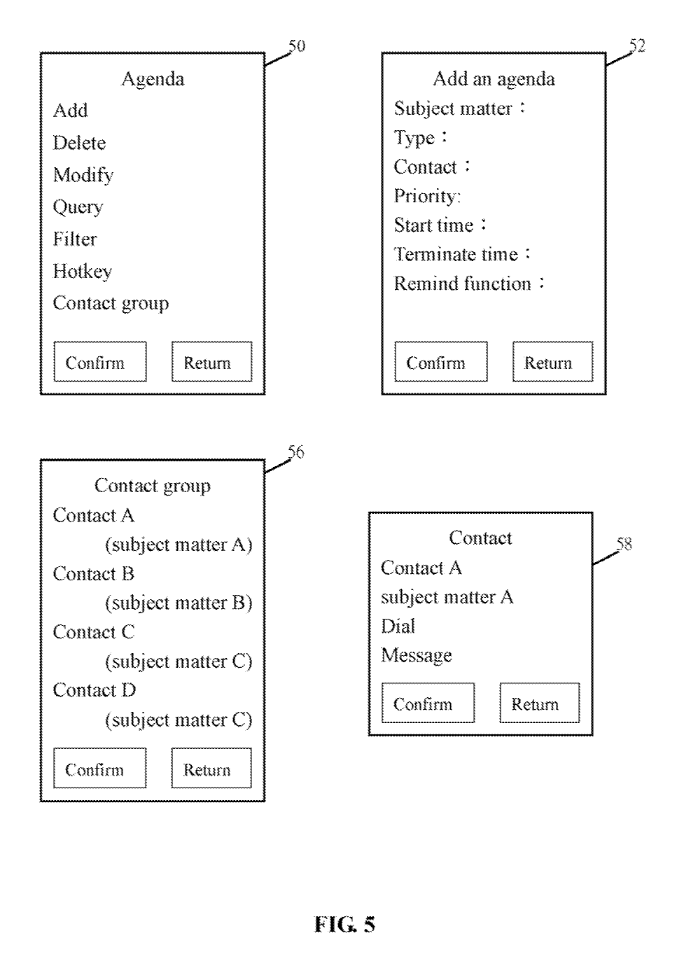

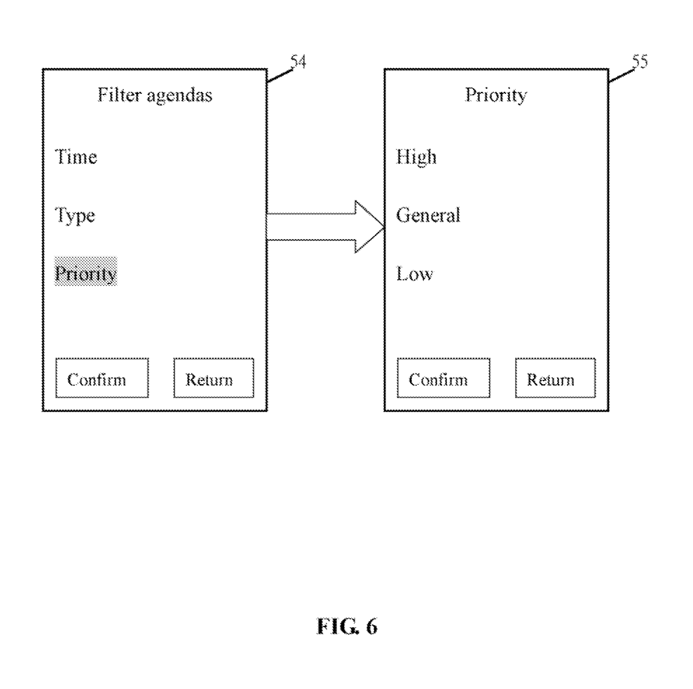

The managing system 2 provides a plurality of user interfaces (as shown in FIG. 5 and FIG. 6) to manage the agendas. The user interfaces are described in detail below.

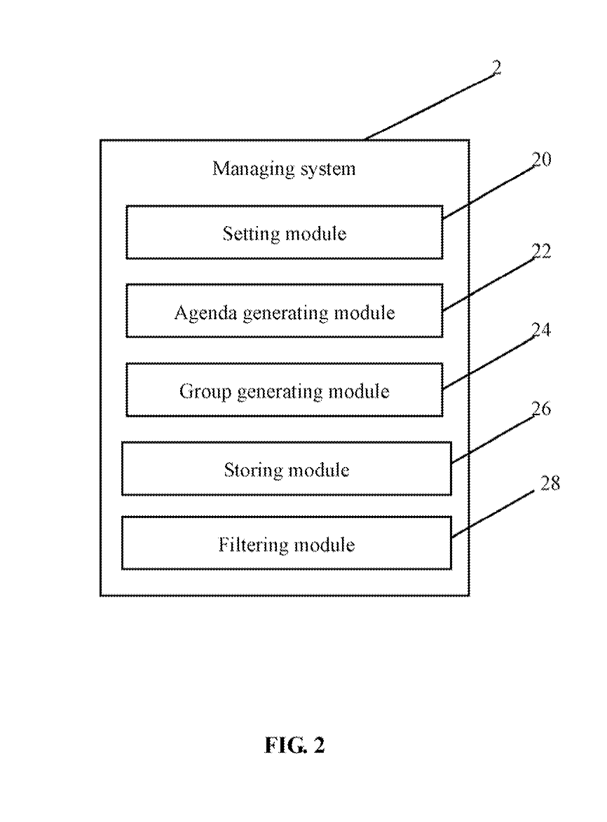

FIG. 2 is a block diagram of one embodiment of the managing system 2. In one embodiment, the managing system 2 includes a setting module 20, an agenda generating 22, a group generating module 24, a storing module 26, and a filtering module 28. The modules 20, 22, 24, 26, and 28 may comprise one or more computerized operations to be executed by the processor 12 to perform one or more operations of the communication device 1. Details of these operations will be provided below.

The setting module 20 allows manipulation of various agenda functions of the communication device 1. As shown in an interface 50 in FIG. 5, the agenda functions may include, but are not limited to, an add function to add a new agenda, a delete function to delete an agenda, a modify function to modify an agenda, a query function to query agendas, a filter function to filter the agendas, a hotkey function to preset a hotkey to invoke the agenda. The setting module 20 also sets a contact group function to generate an agenda contact group corresponding to the agendas.

The setting module further allows configurations of the agendas. As shown in an interface 52 in FIG. 5, the configurations of the agendas may include, but are not limited to, a subject matter, a type, a priority, start time, terminate time, and a reminder function, for example. In one embodiment, the type of each agenda may be an appointment, a meeting, a private business, for example. The priority may include high priority, general priority, or low priority. The reminder function may be an audio alert, a vibration, and/or blinking via the display 14. In addition, the setting module 20 sets a contact option, which may be selected to input contact information corresponding to each agenda. The contact information includes a contact name, a mobile phone number, an E-mail address, a fax number, for example. The contact information may be input via the keyboard 16 or a touch panel of the communication device 1, or be selected from a contact list of the communication device 1.

A user of the communication device 1 may input relevant information via the keyboard 16. The agenda generating module 22 receives the input information, and generates/establishes agendas according to the input information of the user.

In one embodiment, after the agendas are generated/established, the contact group function of the agenda may be invoked to generate the agenda contact group. The group generating module 24 retrieves contact information from the contact option of each of the agendas. The group generating module 24 determines one or more contacts corresponding to the agendas according to the retrieved contact information, and generates the agenda contact group including the determined one or more contacts.

As shown in an interface 56 in FIG. 5, an agenda contact group may include contact A, contact B, contact C, and contact D. In one embodiment, each contact (e.g., A, B, C, D) corresponds to an agenda. For example, contact A may correspond to an agenda including a subject matter A. In another embodiment, more than one contact may correspond to an agenda. For example, contact C and contact D may both correspond to an agenda including a subject matter C. Contacts corresponding to the agendas can be conveniently viewed.

The setting module 20 further presets a hotkey to invoke the agenda contact group, and sets related functions of each contact in the agenda contact group. As shown in an interface 58 in FIG. 5, each contact corresponds to a plurality of related functions, such as a dial function to dial a phone number of contact A, or a message function to send a message to contact A, for example. By utilizing the above mentioned settings, the user may easily invoke the agenda contact group by clicking the hotkey, and then select a contact from the agenda contact group to communicate.

The storing module 26 stores the agenda contact group into the storage system 10.

The filtering module 28 sets filter options to filter the agendas. As shown in an interface 54 in FIG. 6, the filter options may include, but are not limited to, time, types, and priorities, for example. The filtering module 28 receives one or more filter options selected by the user, and filters the agendas according to the one or more filter options. For example, the user may select a filter option “type” to filter all agendas belonging to a type of “appointment.” In another example, the user may select a filter option “priority” to filter all agendas having a priority “high.”

The group generating module 24 further generates a filtered agenda contact group including one or more contacts corresponding to the filtered agendas, and names the filtered agenda contact group. For example, the group generating module 24 generates a filtered agenda contact group including the contacts corresponding to all agendas having a priority “high,” and names the filtered agenda contact group as “high priority group.”

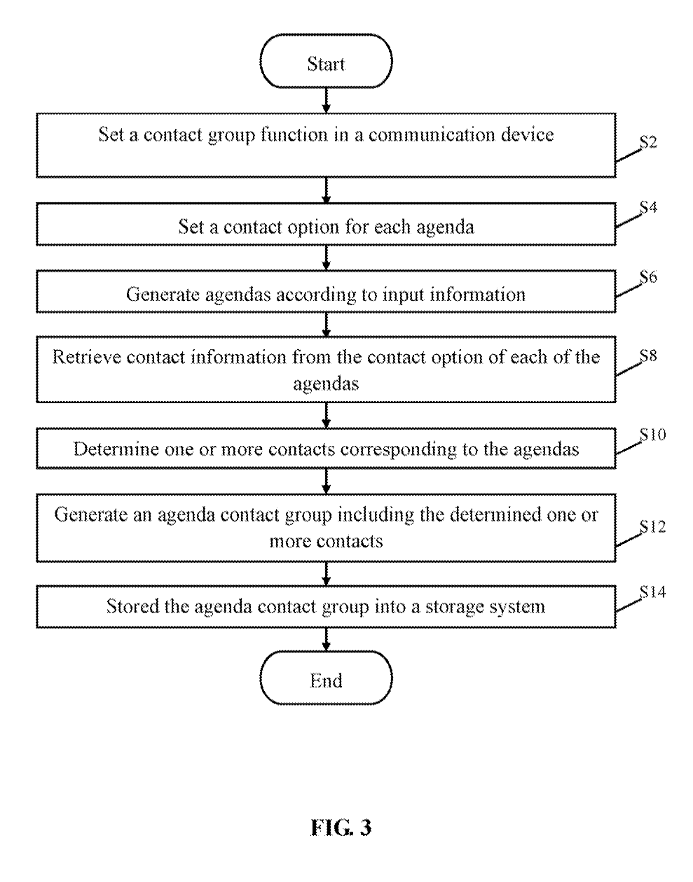

FIG. 3 is a flowchart of one embodiment of a method for managing agendas in the communication device 1. Depending on the embodiment, additional blocks may be added, others removed, and the ordering of the blocks may be replaced.

In block S2, the setting module 20 sets a contact group function to generate an agenda contact group corresponding to the agendas.

In block S4, the setting module 20 sets a contact option for each of the agendas. The contact option may be selected to input contact information corresponding to each of the agendas.

In block S6, the agenda generating module 22 generates the agendas according to input information of a user.

In block S8, the group generating module 24 retrieves contact information from the contact option of each of the agendas.

In block S10, the group generating module 24 determines one or more contacts corresponding to the agendas according to the retrieved contact information.

In block S12, the group generating module 24 generates the agenda contact group including the determined one or more contacts.

In block S14, the storing module 26 stores the agenda contact group into the storage system 10.

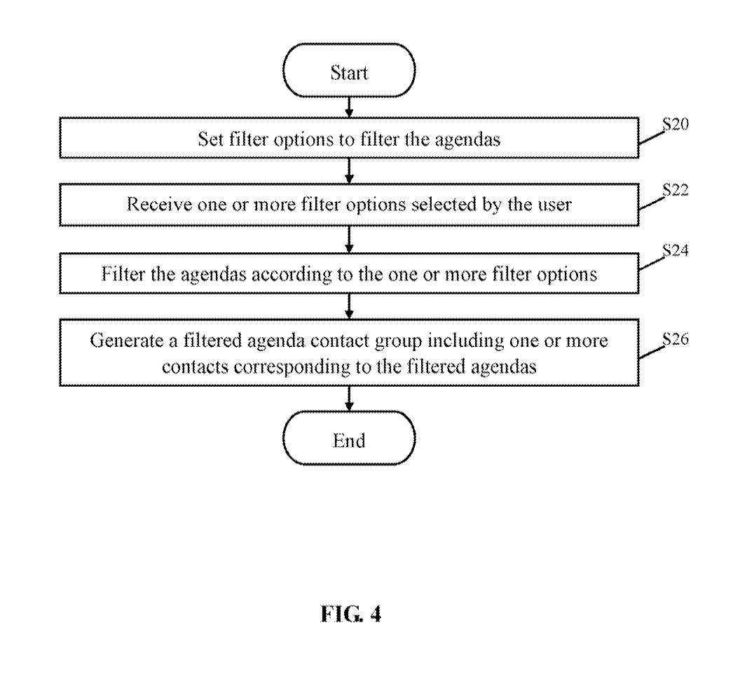

FIG. 4 is a flowchart of one embodiment of a method for filtering the agendas. Depending on the embodiment, additional blocks may be added, others removed, and the ordering of the blocks may be replaced.

In block S20, the filtering module 28 sets filter options to filter the agendas. As mentioned above, the filter options may include time, types, and priorities, for example.

In block S22, the filtering module 28 receives one or more filter options selected by the user. For example, the user may select a filter option “priority” to filter all agendas having a priority “high.”

In block S24, the filtering module 28 filters the agendas according to the one or more filter options.

In block S26, the group generating module 24 generates a filtered agenda contact group including one or more contacts corresponding to the filtered agendas, and names the filtered agenda contact group. For example, the group generating module 24 generates a filtered agenda contact group including the contacts corresponding to all agendas having a priority “high,” and names the filtered agenda contact group as “high priority group.”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing agendas in a communication device, the method comprising:
setting a contact option for each of the agendas;
generating the agendas according to input information of a user;
retrieving contact information from the contact option of each of the agendas;
determining one or more contacts corresponding to the agendas according to the retrieved contact information;
generating an agenda contact group comprising the determined one or more contacts; and
storing the agenda contact group into a storage system of the communication device.

2. The method according to claim 1, further comprising:
naming the agenda contact group.

3. The method according to claim 1, further comprising:
setting filter options to filter the agendas.

4. The method according to claim 3, further comprising:
receiving one or more filter options selected by the user;
filtering the agendas according to the one or more filter options; and
generating a filtered agenda contact group comprising one or more contacts
corresponding to the filtered agendas.

5. The method according to claim 1, further comprising:
presetting a hotkey of the communication device to invoke the agenda contact group.

6. The method according to claim 1, wherein the contact information is input via a keyboard or a touch panel of the communication device, or is selected from a contact list of the communication device.

7. A communication device, the communication device comprising:
a storage system;
at least one processor; and
one or more programs stored in the storage system and being executable by the at least one processor, the one or more programs comprising:
a setting module operable to set a contact option for each of the agendas;
an agenda generating module operable to generate the agendas according to input information of a user;
a group generating module operable to retrieve contact information from the contact option of each of the agendas, determine one or more contacts corresponding to the agendas according to the retrieved contact information, and generate an agenda contact group comprising the determined one or more contacts; and
a storing module operable to store the agenda contact group into the storage system.

8. The communication device according to claim 7, wherein the group generating module is further operable to name the agenda contact group.

9. The communication device according to claim 7, wherein the one or more programs further comprises a filtering module operable to set filter options to filter the agendas, receive one or more filter options selected by the user, and filter the agendas according to the one or more filter options.

10. The communication device according to claim 9, wherein the group generating module is further operable to generate a filtered agenda contact group comprising one or more contacts corresponding to the filtered agendas.

11. The communication device according to claim 7, wherein the group generating module is further operable to preset a hotkey of the communication device to invoke the agenda contact group.

12. The communication device according to claim 7, wherein the contact information is input via a keyboard or a touch panel of the communication device, or is selected from a contact list of the communication device.

13. A storage medium storing a set of instructions, the set of instructions capable of being executed by a processor to perform a method for managing agendas in a communication device, the method comprising:
setting a contact option for each of the agendas;
generating the agendas according to input information of a user;
retrieving contact information from the contact option of each of the agendas;
determining one or more contacts corresponding to the agendas according to the retrieved contact information;
generating an agenda contact group comprising the determined one or more contacts; and
storing the agenda contact group into a storage system of the communication device.

14. The storage medium as claimed in claim 13, wherein the method further comprises:
naming the agenda contact group.

15. The storage medium as claimed in claim 13, wherein the method further comprises:
setting filter options to filter the agendas.

16. The storage medium as claimed in claim 15, wherein the method further comprises:
receiving one or more filter options selected by the user;
filtering the agendas according to the one or more filter options; and
generating a filtered agenda contact group comprising one or more contacts corresponding to the filtered agendas.

17. The storage medium as claimed in claim 13, wherein the method further comprises:
presetting a hotkey of the communication device to invoke the agenda contact group.

18. The storage medium as claimed in claim 13, wherein the contact information is input via a keyboard or a touch panel of the communication device, or is selected from a contact list of the communication device.
